(19) United States
(12) Patent Application Publication
(10) Pub. No.: US 2004/0193485 A1
(43) Pub. Date: Sep. 30, 2004

(54) Small business/retailer/merchant loyalty program

(76) Inventor: Noel Ilberg, Port Washington, NY (US)

Correspondence Address: Thomas A. O'Rourke, Bodner & O'Rourke, 425 Broadhollow Road, Melville, NY, 11747, US

(21) Appl. No.: 10/402,360

(22) Filed: Mar. 28, 2003

(51) Int. Cl. G06F 17/60

(52) U.S. Cl. 705/14; 705/26

(57) ABSTRACT

The present invention is directed to an improved loyalty program that has particular applicability for a small business. The merchant loyalty program enables the small business owner to have a program where the owner can select the desired parameters and rewards given to its customers.

### FIELD OF THE INVENTION

The present invention is directed to an improved loyalty program and especially a small business/retailer/merchant loyalty programs. More particularly the present invention is directed to a small business/retailer/merchant loyalty program that benefits a smaller business that would not otherwise have the financial and other resources as well as other means to create an in-house program that delivers the same set of benefits.

### BACKGROUND

The present competitive retail environment, which includes department stores, franchised establishments, Internet vendors, etc., presents a difficult obstacle for many individually owned, retail stores, and smaller businesses such as family-owned businesses. Many local businesses have difficulty competing with regional and national chains on price and merchandise selection. As a result, many of these local business establishments stress service and occasionally, a more unique product selection as a point of differentiation. Many smaller local establishments have been under competitive pressure and have either folded or sold out to their larger counterparts.

Most often, the small business's fate initially depends on a local, loyal customer base. However, attracting customers in an area where a resource rich larger company has recently moved in or is already doing business may present a problem. Additionally, the smaller business owner will have a smaller advertising budget, while a larger chain, can put a great deal of money and other resources into advertising and marketing initiatives, such as loyalty program.

Even if the business has a good customer base, attracts new customers, and draws some customers away from the larger companies, the small business still has to concentrate on customer retention. This often more difficult than attracting customers, because of the inducements or rewards offered by the larger competitors to lure customers away. Many studies have indicated that the costs of attracting new customers are considerable when compared to the cost of keeping current customers. Small businesses and retailers are at a competitive disadvantage in most markets. Also, a local business owner may be operating at higher relative costs and at times generating a small, if any, profit. A smaller store may not have as many sales per square foot as a larger store. Product price is one essential consideration in customer retention, because consumers will naturally buy the product for as cheap as they can. However, in some markets, price is not as important as service and ease of purchase.

Another competitive advantage of a nationwide chain that enhances its ability to compete and retain customers is a customer reward programs. These programs are based on purchases the customer makes from the company either in the store or elsewhere. For example, a purchase within a store may offer a reward, which may be a discount on the consumer's next purchase in the store. The programs offer discount prices and rewards, such as/certificates/certificates or products. Sometimes these programs offer mileage in an airline's frequent flier program. Also, the programs may involve preferred shopper plans, which allow customers that sign up to receive take a small percentage off every purchase they make in the store. Thus, the customer always knows that he or she is going to receive some benefit when buying items at the large retailer. These reward programs give the larger stores a competitive advantage that local small business/retailer/merchants cannot match because of the high overhead cost of running and administering these programs. There is a significant need within the small business/local small business/retailer/merchant community for an easily maintainable, low cost customer retention program such as the preferred shopper reward plans utilized by larger stores.

### OBJECTS OF THE INVENTION

It is an object of the present invention to provide a customer loyalty program to small businesses to increase their ability to compete with larger companies.

It is an object of the present invention to provide a customer loyalty program that can be tailored to any business.

It is an object of the present invention to provide a customer loyalty program that is cost effective and easy to implement and operate.

It is an object of the present invention to provide a customer loyalty program that allows the business owner to track customer patterns and save customer data.

It is a further object of the present invention to provide a small business/retailer/merchant loyalty program whereby a program network administrator/sponsor runs an affinity small business/retailer/merchant network whereby each small business/retailer/merchant selects the program parameters for that small business/retailer/merchant.

It is also an object of the present invention to provide a small business/retailer/merchant loyalty program whereby each small business/retailer/merchant selects the rewards provided by that small business/retailer/merchant.

It is a further object of the invention to provide a small business/retailer/merchant loyalty program whereby each small business/retailer/merchant selects the amount of points or other award to its customer for a particular level of purchases.

It is a still further object of the present invention whereby the program network administrator/sponsor can provide to any customer of any small business/retailer/merchant an additional inducement, points, as part of the program and to promote cross or intra merchant shopping activity.

It is a still further object of the present invention that the program administrator/network administrator/sponsor will compensate the merchant/small business for the inducement, points, provided to the customer/shopper.

It is a still further object of the present invention that the program administrator/network administrator/sponsor will communicate directly with the customer/shopper.

It is also a further object of the present invention to provide a small business/retailer/merchant loyalty program whereby the network administrator/sponsor or other third party participates and assists the small business/retailer/merchant in the loyalty program to share the expense, (pays for the points/inducement) to share the data and/or provide a greater reward stream.

It is an object of the present invention to provide a small business/retailer/merchant loyalty program operated by a program network administrator/sponsor and in which each small business/retailer/merchant operates independently but the network.administrator and the small business/retailer/merchant share the same customer base and data.

### SUMMARY OF THE INVENTION

The customer loyalty program of the present invention is tailored to small businesses and local small business/retailer/merchants wishing to stay competitive with larger chain stores and franchises. As used herein, the term merchant includes a small business/retailer/merchant. The small business/retailer/merchant loyalty program is intended to generate new revenue and increased profitability. Other advantages of the present invention are that it increases customer retention and reduces customer attrition. The existence. of the program provides a competitive barrier to other, non-member small business/retailer/merchants. The small business/retailer/merchant loyalty program of the present invention is run by a program or network administrator. The program network administrator/sponsor is the common element among all of the small business/retailer/merchants. In one embodiment, all the small business/retailer/merchants perform all of their credit card transactions through the program network administrator/sponsor. The program network administrator/sponsor can be any type of organization such as a bank, a local chamber of commerce etc.

There are benefits to the program network administrator/sponsor in the present invention. For example, the small business/retailer/merchants are locked in for a relatively long term as they are reluctant to drop a program where their customers have a vested interest in continuing. Another benefit to the administrator is access to customer data that would otherwise not be available to the administrator. In the operation of the program the program network administrator/sponsor and the small business/retailer/merchant have access to the small business/retailer/merchant's customer data. This customer data may be shared with other small business/retailer/merchants in the program or may not depending on the intent of the administrator and/or the small business/retailer/merchants.

Initially, the customer will complete a program enrollment form that will ask for basic information, such as the customer's name, address, etc. The customer is then issued an identification means, preferably, but not limited to, a card with a magnetic strip. The identification means may also be a small key tag with a bar code that identifies the consumer. The information that the customer entered on the form may either be coded onto the identification means, or the customer can be assigned a specific number, as in the bar code. When purchases are made the information concerning the purchases can be stored in a suitable database. This database can keep track of the identity of the items purchased, the number of such items and other relevant information for the retail establishment.

The information on the forms will be entered into a database maintained by an systems operator. The systems operator can be a person within the company's organization or more preferably may be with a third party such as a program network administrator/sponsor. The systems operator will oversee the data entry and program administration and implementation from the database standpoint, whereas the business owner will simply develop/define the marketing and merchandising aspects of the program he or she wishes to implement. The systems operator may preferably have responsibility for a number of retail establishments. If desired the customer information may be shared by each of the retail establishments. In addition, there may be cross-fertilization of the customer list among the establishments. The program network administrator/sponsor may be, for example, a bank, a credit card company, a larger small business/retailer/merchant, an organization such as a charity or other suitable group or organization.

The customer loyalty program that the business owner implements can be individualized based on whatever he or she desires: points, total purchases, time-based purchases, etc. For example, a business may devise a program whereby, for every purchase, the customer obtains a pre-selected number of reward points at a given establishment. When the customer has obtained a pre-designated number of reward points at that establishment, he or she can receive a free item, or coupon/certificate for reduction on a subsequent purchase. Each establishment can select the threshold levels for the various customer rewards. Thus, for stores offering lower price items such as a newsstand, the reward level may be less than a store offering higher priced items. The free item, coupon/certificate, discount, etc. intended to entice the customer to continue shopping at that establishment.

The business owner/manager defines the program parameters, while the systems operator implements it within the database. Thus, the database will store each customer's demographic information, as well as points, rewards, etc. that he or she has earned. Additionally, the database may generate customer activity reports, which can be very valuable to the business owner. For example, the business owner may ask to see which customers in particular communities have not been making purchases at his store and may focus his advertising in response to that report. Also, the database may be used to generate mailing lists for the business owner that will increase the owner's intimacy with customers, increasing their loyalty. For example, if the consumer purchases a specific type of product regularly, the storeowner using the database can tailor the advertising pitch or newsletter to that customer.

In conjunction with each purchase, the customer's identification means is passed through a recording means, such as a standard credit-card terminal (CCT). The terminal records the customer's identification information and may either transfer it to the database at that time or it may be stored for transfer to the database at a later time. The recording means also can identify item purchased and the amount of the purchase as entered manually by the retailer or acquired from the cash register. At designated times, the recording means will connect with the database and upload the stored information. The database will then be updated with each customer's points since the last upload. In addition, the database can notify a mailing program to generate a notice of entitlement to the customer. This may be, for example, the sending of a free item or coupon/certificate to a consumer's home address, because he or she has reached a predetermined point threshold. Alternatively, there may be a printing program with the recording means that prints out the coupon/certificate or other reward information at the time of the purchase or at the next suitable time.

In another embodiment, the CCT may contact the database using an interactive dial-up connection to update the customer's points simultaneously with the transaction. In addition, the customer may be able to view his or her total points after the database downloads the figure to an display screen, which will allow the consumer to have real-time points redemption. For example, the customer may see that his or her total points have generated a coupon/certificate for a certain item. The customer may then purchase the item with the coupon/certificate while remaining in the store, and does not have to wait for the coupon/certificate to be mailed.

In yet another embodiment, the owner can utilize a fully integrated Point of Sale (POS) system that will include real-time updates, and also, capture an expanded data set, including promotion and product codes. These features allow the owner to run in-store sales in conjunction with the customer loyalty program.

The customer loyalty program may also be accessible by a customer using a home Internet connection. The customer using his or her Internet Service Provider (ISP), may be able to log on to a database server. There the customer can check total points, rewards received, sales, etc., as well as viewing the overall rewards system.

The customer loyalty program is cost effective and simple to implement. In terms of management, the owner of the business must simply devise a marketing and merchandising program and instruct the systems operator on how the program should work. Then, the owner has the ability to make changes, but has no other responsibilities in the administration of the program, database, or database server, as the case may be. Also, the owner can generate customer activity reports that will provide valuable demographic information for advertising purposes. The costs incurred for implementation of the program may include a CCT, printing identification means for customers, and administration fees for the database. But, the cost of database administration will be defrayed because the systems operator may be able to manage several customer loyalty programs simultaneously. The costs of the program are slight and will most likely be outweighed by the benefit of increased customer activity and loyalty.

### BRIEF DESCRIPTION OF THE DRAWINGS

FIG. 1 is a flowchart of the loyalty program of the present invention showing the first tier of the program.

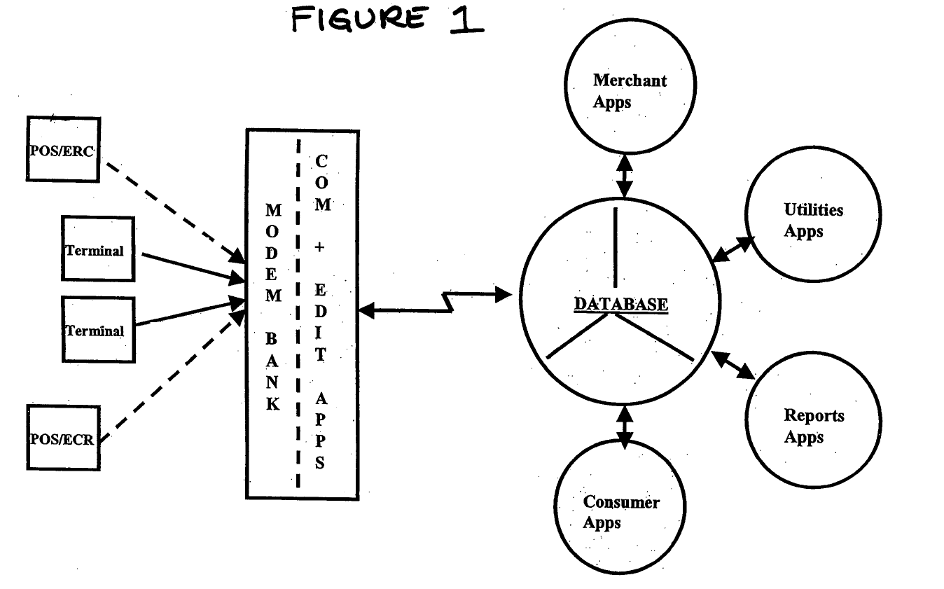

FIG. 2 is a flowchart of the loyalty program of the present invention showing the systems interface.

### DETAILED DESCRIPTION OF THE INVENTION

In one embodiment of the invention there is a core loyalty program run by a program network administrator/sponsor in which, the parameters of the program are set by each individual small business/retailer/merchant. The network administrator or program manage may, for example, enroll one or more small business/retailer/merchants or other organizations in the program. Each small business/retailer/merchant determines the type of rewards available through that individual small business/retailer/merchant. The small business/retailer/merchant also determine the “point” basis for each transaction. More specifically, the small business/retailer/merchant may determine what the customer receives for dealing with the small business/retailer/merchant. Will it be a coupon/certificate, a gift or other token of value. In addition, the small business/retailer/merchant determines the types of transactions that are entitled to points or other value. Thus, for example, the small business/retailer/merchant may exclude certain types of products or services from the program. Alternatively, the small business/retailer/merchant may set other parameters for the award of points.

The present invention differs from the traditional loyalty program in that the program network administrator/sponsor in the prior programs determines the rewards and how the points are accumulated. In addition, the small business/retailer/merchants who participate in the program typically have no say in what the rewards are and how they are accumulated. Here, each small business/retailer/merchant makes the determination as to how he will participate.

The purchaser presents his identifier to the small business/retailer/merchant. The identifier may be tag or other indicator that preferably may be read by a reader means. The purchases are tallied by the small business/retailer/merchant and stored in a data storage means. Points are issued through a credit card type terminal. The receipt issued by the terminal notes the total number of points earned in the transaction. In some instances, points may be awarded not just by the small business/retailer/merchant but also by other small business/retailer/merchants who are in a cross marketing arrangement with each other. The receipt issued by the terminal may also identify any cross small business/retailer/merchant points that are awarded for the transaction. Points may be redeemed by any suitable means such as reward certificates, gift cards etc. The small business/retailer/merchant or a central repository may retain the customer information generated by the transaction. The information stored may be limited to name and address or more detailed information may be retained. From the customer information mailing lists and appropriate messages and other types of communications can be developed as desired by the small business/retailer/merchant or the systems operator. If desired, the information generated by the trans action may be supplied to other establishments in the network so that other contacts can be developed from the information. For example, a restaurant or caterer to provide the basis for a pitch to the customer may use information obtained from a party store about customer activity. The retail establishment that the customer made the purchase can use the information obtained and determine the types items purchased and their frequency so that reminders in the form of for example, a notice or a coupon/certificate can be issued.

In another embodiment of the present invention there can be additional features. For example, there may be on-line reward redemption. In this instance, the customer who has reached a threshold may access the operation managers website and print out a coupon/certificate or other designation of his level of reward. Alternatively, the reward can be redeemed at the retail establishment. In this instance, the purchaser can receive the reward when he is checking out his purchases at the register without delay.

The customer can access the account information by a variety of means. One means is by telephone. Another is through the Internet; a third is through a terminal or kiosk at the retail establishment. Another means of accessing the information is though the receipts issued by the store for additional purchases.

In another embodiment, the method and system of the present invention may store purchase data information from a customer's purchase. From this information, a shopper preference analysis can be performed. From this analysis purchase predictability modeling can be determined. Using the modeling, customer specific promotions can be generated.

In operation, a customer or a potential customer completes an enrollment form. The enrollment form can be generated by the customer in the retail establishment, on line, by telephone etc. Typically, the form will seek primary information, the customer's name, address etc. If additional information is sought such as employment information and salary data that information can be obtained as well. The information so obtained can be transferred to an operations center for entry into a database.

After enrollment, the shopper is provided with an ID tag. The ID tag may be mag-striped or bar coded if desired. When the shopper is performing a transaction the card can be swiped at a reader for each purchase transaction. Points may issue against the sale. These points may be based on any parameter selected by the small business/retailer/merchant—dollar sales, gallons, etc. Points can automatically calculated at the terminal or transferred to the operations center for calculation. The total points awarded in the transaction are provided to the customer usually in the form of the receipt for the transaction.

Each small business/retailer/merchant in the program can determine its individual reward levels. In one embodiment, once the pre-selected points total has been reached a small business/retailer/merchant reward certificate can be issued. This may issued automatically or if preferred by the customer, the points can be banked for future use or a larger reward.

The terminal may be a credit card terminal, which interacts with a transaction fed database. There are also preferably CRM analytical programs and a comprehensive reporting package. In addition, there may also be dial up and Internet support.

The small business/retailer/merchant portion of the system and method of the present invention preferably is a closed loop community of small business/retailer/merchants and their shoppers. The systems operator partners with the small business/retailer/merchants to deliver the loyalty program. The systems operator may have responsibility for a single small business/retailer/merchant or a plurality of small business/retailer/merchants. In one embodiment, the systems operator may be a bank or other similar organization. Where the systems operator has a plurality of small business/retailer/merchants in the program there are additional benefits to the participants. One benefit is that the systems operator can provide additional reward opportunities for customers of one small business/retailer/merchant who subsequently do business with other small business/retailer/merchants in the program. A logo or other indicia can be used to identify members of the program.

If desired, the program may be limited in a variety of ways to enhance value to the small business/retailer/merchants. For example, the program may be limited to small business/retailer/merchants in a particular geographic-location, such as a mall or down town area of a small town. Another means of enhancing value to the program can include limiting participation to a limited number of retail establishments of a particular type. For example, there may be only one or a limited number of restaurants. In one embodiment, the restaurants can be limited to even particular types of restaurants. Depending on the type of retail establishments participating, there may be restrictions placed on access to portions of the database to preserve independence and competition.

The following is a detailed description of the system and method of the present invention that delivers “large retailer” loyalty program functionality to smaller, “mom & pop” type retailers that cannot afford to design, build and operate their own in-house loyalty program/system. In one embodiment, the management component can be outsourced to an appropriate “technology driven” third party that will be responsible for the overall management of the program. Alternatively, the program may be monitored by the retailer participating in the program. The system and method of the present invention can also operate offline from a central system—characterized as store and forward transaction orientation that minimizes communication cost. In still another embodiment the invention can have an interactive dial-up connection to a central system/host db for immediate points updating and real-time points redemption. In a further embodiment, the system and method of the present invention can be fully integrated with the retailer POS and capture an expanded data set including UPC/SKU product or promotion codes.

Functional Description

Overview

The program is designed to be multi-phased with preferably three phases. The first phase may be implemented expeditiously. The other embodiments add additional functionality. Retailers may opt to stay with the first or phase/tier 1 functionality as the extra functions may not be relevant to them. The implementation permits phase 1 to be instituted quickly, but is designed in a manner that phases 2 and 3 can build on the base.

The system and method is preferably card-based. The card is swiped on a standard credit card terminal (CCT) and the retailer enters the transaction total. The customer is awarded points based on the transaction total. Daily the transactions are uploaded to the central server/db operating environment. There the master database is updated with the transactions. When a retailer defined points level/threshold is reached, a reward certificate is generated and delivered/mailed to the shopper. In this embodiment the certificate is good at that retailer's store(s) only.

Periodically, reports are run against the customer database and the results may be delivered/mailed to the retailer.

Credit Card Terminal (CCT) Function

The CCT is preferably but not required to be stand-beside i.e. not fully integrated with or embedded in the Point Of Sale (POS) system. POS integration is also feasible, but the solution must be capable of working stand-alone. The initial implementation may use Hypercom CCTs, Verifone CCT's and others.

On completion of the POS sales transaction, the retailer presses a key on the CCT that signifies that this is a loyalty transaction. The application prompts for the retailer to swipe the loyalty card and manually enters the transaction total either expressed as dollars or another unit of measure integral to the small business/retailer/merchant operation for which a reward is being provided, i.e. gallons of fuel.

Preferably, the store clerk does not have to enter an operator number and therefore the system does not capture the identity of the clerk. This approach is taken because the target environment will have very few operators per store—often just the owner and 1 or 2 others. It also slows the process, requiring entry of the operator number for every transaction. Typically, there will be a transaction dollar limit (parameter—retailer defined) above which the operator will be asked to confirm that the transaction amount is correct. There need not an override number required, simply yes/no confirmation will frequently do. Override number support can be added if desired.

The CCT application code should support a function to void the previous transaction. This allows the operator to correct a keying error and to redo the transaction. The voided transaction need not be deleted from the CCT as both the original transaction and the void function are logged to provide an audit trail. The CCT used will also have multi-application support. It should be able to handle credit and debit requests using software provided usually by the CCT manufacturer (or credit service provider). A terminal application software developer will develop the terminal loyalty application. Pressing the “loyalty key” invokes the loyalty application.

The loyalty application in the CCT calculates how many points are awarded based on an algorithm that is downloaded to the CCT. This algorithm is a simple conversion factor as to how many points are awarded per dollar spent or gallons of fuel pumped. The CCT prints out a receipt for the customer that includes the customer account number, store name and location, date, time, total points awarded. An option allows a second receipt to be printed for the retailer to keep.The reward receipt will usually print a limited amount of transaction related information. It is expected that there will be a few templates from which the retailer can choose, and then be allowed to specify the content of a few lines for personalization e.g. the first 6 lines, which would allow, for example:

Thank you for shopping at M&P's

M&P Convenience Store

1600 Our Street

Any City, 121345

(405) 555-1234

www.mandp.com

In the first embodiment, there is usually no data kept at the CCT apart from that captured from the card and the transaction/points details. In this instance, there will be no way to print the customer's name on the receipt. In other embodiments, the customer's name will be obtained from the central database when the transaction is authorized. If the card will not swipe, the retailer will be able to key-enter the card number. The card number will be checked for accurate keying using the standard credit card ‘mod 10’ validation scheme/method.

The loyalty application stores the transaction in terminal memory. Given the anticipated volumes of typically less than 100 transactions per day, the need for data compression in phase/tier1 is probably not warranted, but should be considered if necessary. The CCT should permit the operations center to collect the stored transactions. The operations center may also download, new points algorithms, new receipt templates and custom data, new versions of the loyalty application.

The loyalty application will store any problem diagnostic information (e.g. error logs) in memory and these will be retrieved to the host in the nightly or other transmission. Error logging will be minimal to prevent using memory needed for transaction data and to minimize the length (and cost) of the polling session. If the CCT starts to run low on memory before it is polled, it preferably should automatically call the operations center. The CCT and operations server will need security mechanisms such as exchanges of IDs before allowing data transfer to occur. The retailer must have a way of interrupting the transmission if the CCT is needed for a credit/debit transaction. On completion of a transmission, the CCT prints a result on the receipt i.e. date/time and whether the transmission was successful.

The loyalty application will store any problem diagnostic information (e.g. error logs) in memory and these will be retrieved to the host in the nightly or other transmission. Error logging will be minimal to prevent using memory needed for transaction data and to minimize the length (and cost) of the polling session. If the CCT starts to run low on memory before it is polled, it preferably should automatically call the operations center. The CCT and operations server will need security mechanisms such as exchanges of IDs before allowing data transfer to occur. The retailer must have a way of interrupting the transmission if the CCT is needed for a credit/debit transaction. On completion of a transmission, the CCT prints a result on the receipt i.e. date/time and whether the transmission was successful.

Operations Center

The operations center preferably contains the master database, the ability to poll stores for the transaction details, customer point managements, reward certificate notification and retailer reporting.

Database

The database preferably contains the following:

Retailer table

Name, number, address, start date, etc.

Reports chosen

Settlement/bank information

Store table (there can be many per retailer)

Store number, address

CCT phone details

Terminal(s) numbers/ID,

Points algorithm

Receipt template

Custom receipt data

Reward certificate template

Custom reward certificate data

Customer table

Loyalty number

Name, address, etc.

Current points total

Reward history

Transaction data

Detailed transaction history, keyed by customer

Polling CCTs

The operations center, on a daily basis should dial each terminal to collect reward transaction information from the CCTs. Polling technique is identified in order to keep communications and hardware costs at a minimum. As the program evolves, this approach may be modified so that the terminal will dial the host and download the daily activity.

The operations server is preferably managed using web-based applications. The web-based approach should allow:

Remote administration

Remote data entry

Retailer access their data, a retailer option

Customers access their data, a retailer option

The web-based management applications include:

Scheduled event definition

Event log viewing

Status of polling

Status of processing transaction data

Retailer configuration

The central server should also support bulk load into the database of customer details. Consumer enrollment information data entry will be performed by a third party organization, however a data format needs to be defined. In other embodiments, an IVR system may be implemented to allow customer access to points balances and other customer service functionality.

Points Management

When the transaction data is retrieved, it may be edited, parsed and the database populated. Any customer that has reached a retailer pre-defined reward level is identified as being entitled to a reward certificate. Retailers will be given the option of printing and distributing the reward certificates or having the function outsourced. The reward certificates are defined by several standard templates, which incorporate some retailer-defined text for personalization.

The process of printing the reward certificates will generate the certificates and store them in soft copy form before printing. This will allow the certificates to be transmitted to a third party printing house for bulk printing and mailing if desired. E-mailing the certificates is also feasible.

Retailer Reports

Various reports can be generated through the system. There will be a “standard” set of reports for all retailers, custom reports can also be created. The process of printing the reports will generate the reports and store them in soft copy form before printing. This will allow the reports to be transmitted to a third party printing house for bulk printing and mailing. It also allows e-mailing reports or viewing them online, an option for the retailer. The reports can include one or more of the following. The reports can include any or all of the information outlined or other desired information:

Customer List

This will show for each customer that has used a card at that retailer, sorted by total points balance:

Current Points Balance

Lifetime Points total

Name and address details

Enrollment date

Last activity date

Total number of visits

Total number of redemptions

Activity Report

This shows the activity for each day of the month.

Date

Points awarded that day

Cumulative points issued

Points redeemed that day

Net points outstanding (Cumulative points issued—Points redeemed)

Inactive Customer Report

This produces a list of all customers at that retailer that have had no activity in the last “X” months, sorted by last activity date. The system preferably never automatically deletes customers that have not used the card or are defined as inactive. The merchant usually has to specifically request that consumers be removed from the database.

Name and address details

Last activity date

Points balance

With the reports, the server can also generate the monthly invoice for the retailer.

Settlement

The central server will settle automatically using pre-authorized debit (ACH) service. Frequency of settlement will vary from weekly to monthly based on the account.

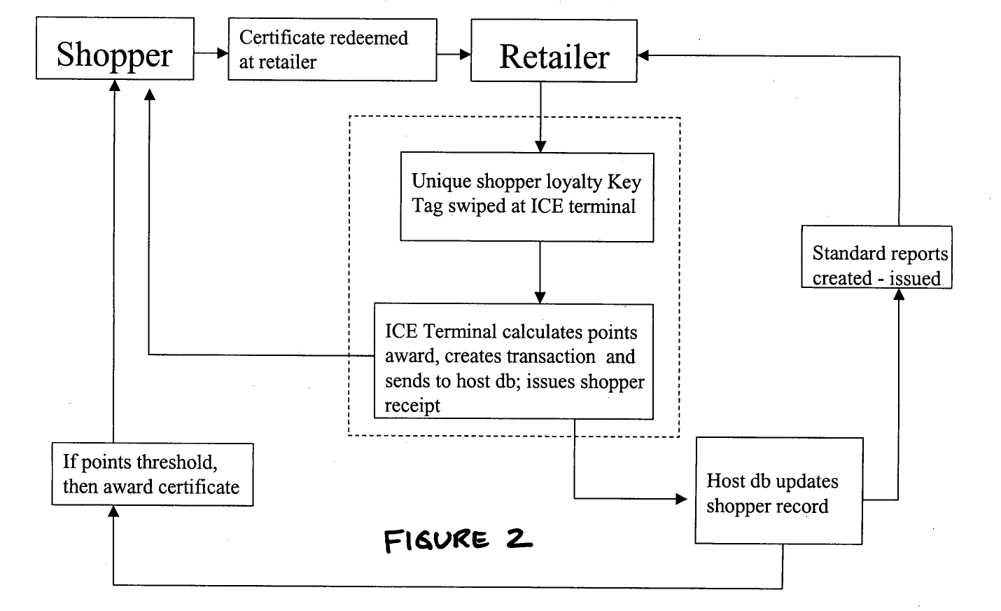

As used in FIG. 2, the designation POS refers to point of sale. ERC denotes electronic capture and storage of transaction receipts.

1. A merchant loyalty program comprising one or more merchants, each merchant having a personalized reward scheme for its customers and a personalized point basis awarded for purchases and for determining whether a customer is entitled to a customer reward, each point basis being selected by each of said merchants for said merchant's customers, a recording means for recording each transaction of an enrolled customer, a database for storing said transactions and an administrator for monitoring the program transactions for each merchant and issuing rewards to said enrolled customers.

2. The program according to claim 1 wherein said administrator provides inducements to purchase, adapted to each merchant's plan to said merchant's customers.

3. The program according to claim 2 wherein database is unique for each merchant and maintained separately from the databases of other merchants.

4. The program according to claim 1 wherein said merchant and said administrator co-brand the program to said customers.

5. The program according to claim 1 wherein each customer is provided an identification means for said recording means to record each transaction.

6. The program according to claim 5 wherein said identification means can be used at each merchant in the program.

7. The program according to claim 1 wherein each merchant determines the covered transactions in each merchant's reward scheme.

8. The program according to claim 1 wherein a network sponsor pays the merchant for the points provided to the customer within the merchant's loyalty program

9. The program according to claim 1 further comprising a home merchant and a cross transaction merchant, and wherein a customer receives a reward by both said home merchant and said cross transaction merchant for a purchase.

10. The program according to claim 1 wherein said point basis may be changed by said merchant.

11. The program according to claim 1 wherein said merchants share customer data.

12. The program according to claim 1 wherein customer data of each merchant is not available to other merchants.

13. The program according to claim 5 wherein said identification means is a key tag.

14. The program according to claim 13 wherein said key tag has a bar code.

15. The program according to claim 13 wherein said key tag has a magnetic strip.

16. The program according to claim 5 wherein a merchant may vary the number of points awarded based on merchant determined sales goals.

17. The program according to claim 5 wherein each merchant can select the threshold levels for its customer rewards.

18. The program according to claim 5 wherein said database generates merchant specific customer reports for each merchant.

19. A system for managing a merchant loyalty program comprising a data input terminal at one or more merchants, a means for storing a merchant personalized reward scheme for each merchant's customers and a merchant personalized point basis award for purchases and a means for determining whether a customer is entitled to a customer reward, each point basis being selected by each of said merchants for said merchant's customers, a recording means for recording each transaction of an enrolled customer, a database for storing said transactions and an administrator for monitoring the program transactions for each merchant and issuing rewards to said enrolled customers.
